(19) United States
(12) Patent Application Publication
(10) Pub. No.: US 2012/0062384 A1
(43) Pub. Date: Mar. 15, 2012

(54) Roof drain overflow sensor

(75) Inventors: Stephen Jerald McDanal, Montgomery, AL (US); William Anthony Stanaland, Montgomery, AL (US)

(73) Assignee: Jay R. Smith Manufacturing Company, Montgomery, AL (US)

(21) Appl. No.: 12/807,804

(22) Filed: Sep. 14, 2010

(51) Int. Cl. G08B 21/00

(52) U.S. Cl. 340/605

(57) ABSTRACT

An exemplary embodiment providing one or more improvements includes a positive acting sensor which detects the flow of water through a flat roof secondary or emergency roof drain. In embodiments a signal from the sensor is conveyed by a conductor or by wireless means to an alarm box. In embodiments the alarm box provides an audible and or a visual signal indicating a minimal water flow in the secondary drain.

### CROSS-REFERENCES TO RELATED APPLICATIONS

Not Applicable

### STATEMENT REGARDING FEDERALLY SPONSORED RESEARCH OR DEVELOPMENT

Not Applicable.

### THE NAMES OF THE PARTIES TO A JOINT RESEARCH AGREEMENT

Not Applicable.

### REFERENCE TO A “SEQUENCE LISTING,” A TABLE, OR A COMPUTER PROGRAM LISTING APPENDIX

Not Applicable.

### BACKGROUND

This invention relates to the detection of flow in secondary or back-up flat roof drain systems.

### BACKGROUND

### DESCRIPTION OF RELATED ART INCLUDING INFORMATION DISCLOSED UNDER 37 CFR 1.97 AND 37 CFR 1.98.

Flat roofs do not enjoy the intrinsic drainage of precipitation of sloped roofs. Flat roofs would accumulate such precipitation without the incorporation of multiple drains, termed primary drains. Such drains are equipped with strainers to exclude debris such as leaves and branches and ice, thereby preventing clogging of the drain. Nevertheless, primary drains do become blocked by debris and ice, or may simply be overcome by excessive precipitation, with the risk of overcoming the structural integrity of the roof. Secondary or emergency drains are also provided to relieve the water level when the primary drains become clogged and the water level on the roof raises. It is important to building users to become aware the a secondary drain is operating removing water from the roof, so the user can go to the roof and unblock the primary drains or so the user can appreciate the incapacity of the primary system to control the rainwater overload on the roof. Embodiments of the present application provide indication to the user that the secondary drain is in operation.

Some engineers and municipalities were providing or requiring secondary drain systems before they were required by code. The addition of a secondary system proved a sound engineering decision as the importance of this secondary system is understood and recognized by all codes. The need to know when the secondary systems are in actual use is important as it alerts the building owner of a potential problem with the primary system, whether it be a problem with debris at the roof drain dome or an actual stoppage in the piping system. One major code requires the secondary system be discharged separately and at a location where it can be observed by pedestrians. Also, inclement weather can reduce the number of knowledgeable pedestrians around a given building that would notice emergency overflow drains in operation. Therefore, a third overflow indicator would be advisable.

U.S. Pat. No. 4,248,258 discloses a flat roof solar powered auxiliary drain system having multiple modules which drain various sections of a roof. An electrical probe sensor activates pumps when water on the roof reaches a predetermined depth.

U.S. Pat. No 4,596,266 discloses a system for removing rain water from hydrocarbon storage tank floating roofs. A water sensor uses electrical conductive means to detect the presence of water.

U.S. Pat. No. 5,218,346 discloses a low volume flow meter. A watermill-like device rotates in the presence of flow.

U.S. Pat. No. 5,378,356 discloses a flat roof drain structure with a drain and an overflow drain.

U.S. Pat. No. 5,864,287 discloses a system for monitoring the operation of sensors in a fire-suppression system in which flow is sensed. A paddle positioned transverse to the direction of fluid flow in a conduit is moved by fluid flow, stimulating a resulting electrical signal.

U.S. Pat. No. 6,594,966 discloses a bi-functional roof drain which combines in one structure a primary drain outlet and a backup drain pipe.

U.S. Pat. No. 6,696,965 discloses a rotary paddle bin monitor in which a normally freely rotating paddle is inhibited from rotating by the accumulation of dry bulk material in a bin, thereby causing the rotation of a motor housing and stimulating a magnetic sensor.

U.S. Pat. No. 6,786,091 discloses a mechanical process for detection of overflow of a gutter.

U.S. Pat. Applic. Pub. No. 2006/0033629 discloses a overflow sensor for a backup roof drainage system in which the flow of water in the system is detected by the conductivity of water flowing over electrodes embedded in a pipe.

The foregoing examples of the related art and limitations related therewith are intended to be illustrative and not exclusive. Other limitations of the related art will become apparent to those of skill in the art upon a reading of the specification and a study of the drawings. Embodiments of the present application provide solutions to the problem of detecting primary drain blockages which are effective, reliable, and inexpensive.

### BRIEF SUMMARY

The following embodiments and aspects thereof are described and illustrated in conjunction with systems, tool and methods which are meant to be exemplary and illustrative, not limiting in scope. In various embodiments, one or more of the above-described problems have been reduced or eliminated, while other embodiments are directed to other improvements.

Embodiments include an alarm system for detecting the flow of water in a secondary emergency overflow roof drainage system having at least a portion of its conduit in a horizontal orientation, the alarm system comprising, a flow sensor in the horizontal conduit of the roof drainage system comprising, a flow switch with a switch base, the flow switch attached to the horizontal conduit wall with the switch base extending into the conduit lumen. A flow sensor vane, the vane pivotally connected to the switch base, the vane extending from the switch base into the lumen of the conduit, the length of the vane approximating 90% of the diameter of the conduit. The vane is oriented in the conduit so the flow of water in the conduit causes the vane to swing about the pivot connection. The flow switch converts the vane position into an electrical value. An alarm box provides a visual or audible signal in response to a predetermined electrical value, and conductor means convey an electrical value from the flow switch to the alarm box. In embodiments, notification of flow in the secondary emergency overflow roof drainage system is by both visual and audible alarms.

In addition to the exemplary aspects and embodiments described above, further aspects and embodiments will become apparent by reference to the drawings and by study of the following descriptions.

### BRIEF DESCRIPTION OF THE DRAWINGS

FIG. 1 is a cross-section of a flat roof building showing a primary drain to the sewer system and overflow drain with an embodiment flow detection system.

FIG. 2 is a cross-section of a flat roof building showing a primary drain to the sewer system and overflow drain which use a common drain conduit with an embodiment flow detection system.

FIG. 3A is a cross-section of an horizontal conduit taken along the conduit length showing an embodiment sensor.

FIG. 3B is a cross-section of an horizontal conduit along a diameter of the conduit showing an embodiment sensor.

FIG. 4 is the front of an embodiment alarm box.

FIG. 5 is a cross-section of a flat roof building showing a primary drain and overflow drain with a second embodiment flow detection system.

FIG. 6A is a cross-section of an horizontal conduit taken along the conduit length showing a second embodiment sensor.

FIG. 6B is a cross-section of an horizontal conduit along a diameter of the conduit showing a second embodiment sensor.

FIG. 7 is the front of a second embodiment alarm box.

### DETAILED DESCRIPTION

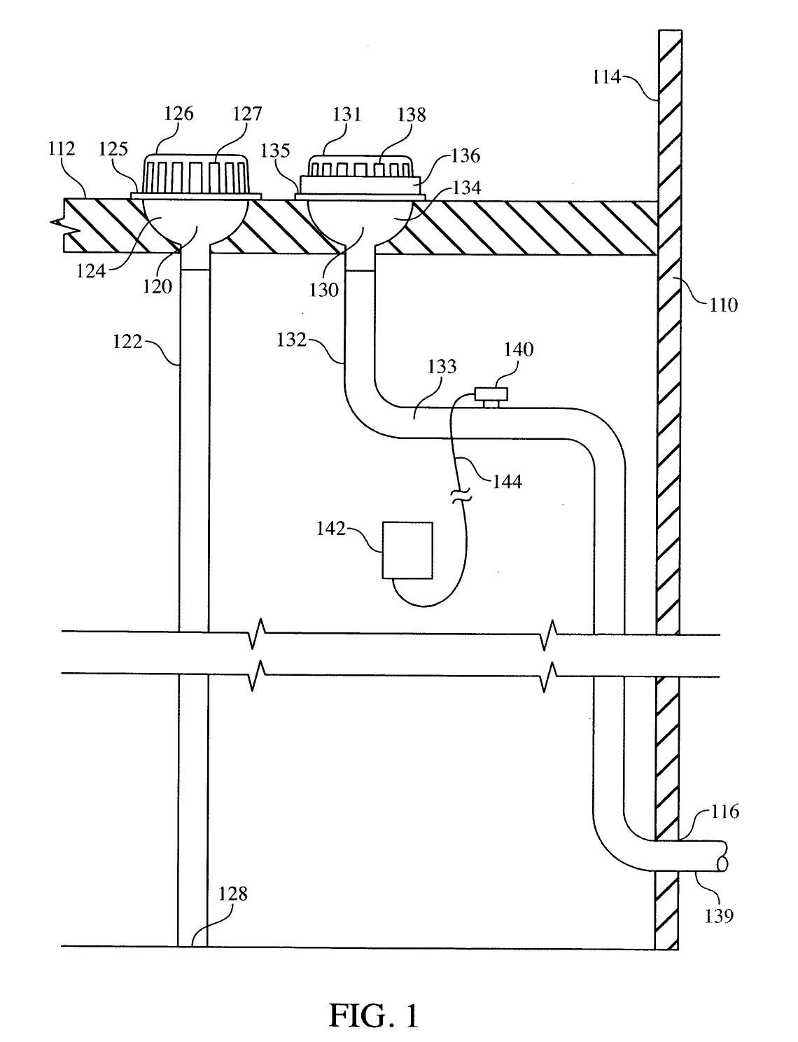

FIG. 1 is a cross-section of a flat roof building showing a primary drain and overflow drain with an embodiment flow detection system. The vertical wall 110, flat roof 112, and roof parapet 114 are depicted schematically.

One or more primary drains 120 are set into the flat roof and provide the main drainage from the roof. Visible in FIG. 1 are the drain bowl 124, the primary drain conduit 122, which carries the water to a primary drain discharge, in this case the building sewer system. Shown on the surface of the roof is the drain rim 125, primary drain strainer 126 with primary drain strainer openings 127 which allowed the entry of water from the roof into the primary drain.

One or more secondary or emergency or overflow drains 130 are also set into the flat roof and provide drainage after water accumulates on the roof beyond the capacity of the primary drains. Visible in FIG. 1 are the drain bowl 134, the secondary drain conduit 132, which carries water from the secondary drain via a horizontal portion 133 of the conduit to the secondary drain discharge 139, in this case an opening on the external wall 116. Shown on the surface of the roof is the drain rim 135, secondary drain strainer 131 with secondary drain strainer openings 138 which allowed the entry of water from the roof into the primary drain. Also shown in the secondary drain dam 136 which prevented the flow of water into the secondary drain until the level of water on the roof exceeded the height of the secondary drain dam 136.

A flow sensor 140 sensed the presence of flowing water in the horizontal conduit or pipe 133 of the secondary drain. The sensor mounts on top of the horizontal conduit 133 with a non-corrosive vane located in the conduit. The vane does not impede flow through the conduit. A signal from the flow sensor is sent via a connector 144 to the alarm box 142 which can be located in a central facility monitoring system. The sensor switch can be wired for either normally open or normally closed operation. The alarm box provides an audible and a visual signal of the presence of water flow in the secondary drain. The signal from the sensor is activated by a certain minimal amount of flow, in embodiments, 5 gallons per minute. The alarm box indicates the presence of a significant amount of flow in the secondary drain, and thus the seriousness of the drainage problem.

In the face of extensive rain or melting ice and snow, water will accumulate on the area of the flat roof 112 between the parapet walls 114. Excessive accumulation of water encourages leaks in the roof and, more importantly, challenges the structural integrity of the roof The water is drained by the generally multiple primary drains 120. If the primary drain or drains is plugged by debris, or is simply overwhelmed by the rate of raining, the level of water on the roof rises over the height of the secondary drain dam 136, and is drained through the secondary drain. Embodiments provide signals of the usage of the secondary drain and inform the building user of the need to monitor the condition of the primary drains and assure they are clear and adequately working.

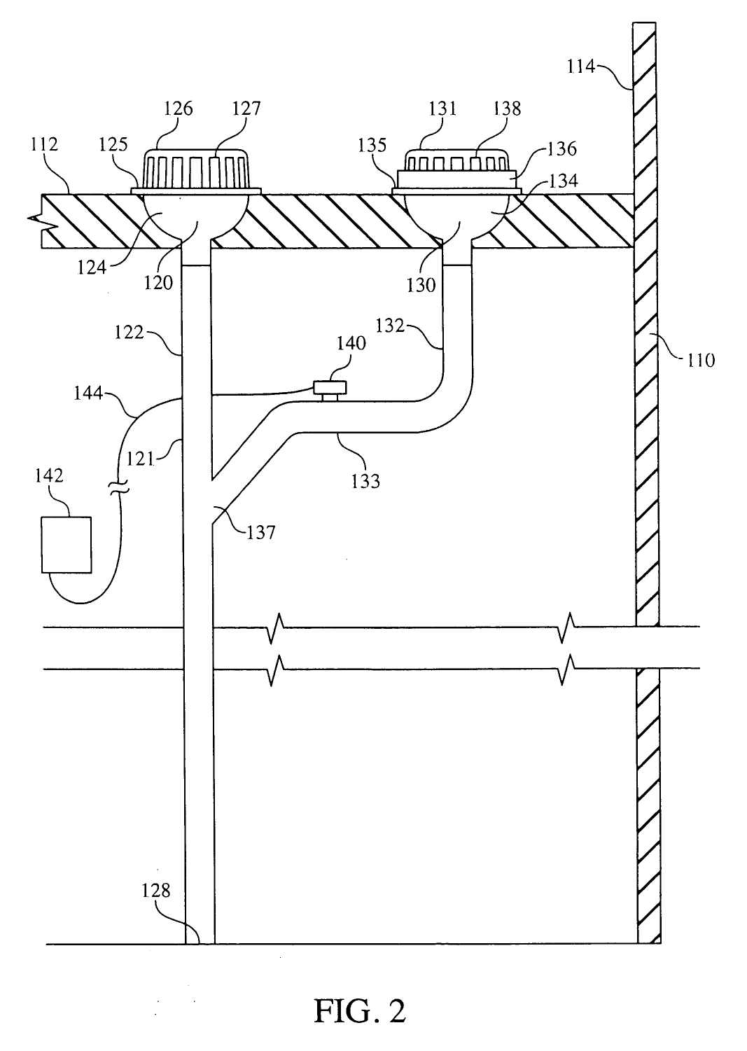

FIG. 2 is a cross-section of a flat roof building showing a primary drain and overflow drain which use a common drain conduit with an embodiment flow detection system. The vertical wall 110, flat roof 112, and roof parapet 114 are depicted schematically.

One or more primary drains 120 are set into the flat roof and provide the main drainage from the roof Visible in FIG. 2 are the drain bowl 124, the primary drain conduit 122, which carries the water to a primary drain discharge, in this case the building sewer system 128. Shown on the surface of the roof is the drain rim 125, primary drain strainer 126 with primary drain strainer openings 127 which allowed the entry of water from the roof into the primary drain.

One or more secondary or emergency or overflow drains 130 are also set into the flat roof and provide drainage after water accumulates on the roof beyond the capacity of the primary drains. Visible in FIG. 2 are the drain bowl 134, the secondary drain conduit 132, which carries water from the secondary drain via a horizontal portion 133 of the conduit In this configuration the secondary drain conduit is connected to and drains into the primary drain conduit 122 at a connection 137. Shown on the surface of the roof is the drain rim 135, secondary drain strainer 131 with secondary drain strainer openings 138 which allowed the entry of water from the roof into the primary drain. Also shown in the secondary drain dam 136 which prevented the flow of water into the secondary drain until the level of water on the roof exceeded the height of the secondary drain dam 136.

A flow sensor 140 sensed the presence of flowing water in the horizontal portion of the conduit 133 of the secondary drain. A signal from the flow sensor is sent via a connector 144 to the alarm box 142. The alarm box provides an audible and a visual signal of the presence of water flow in the secondary drain.

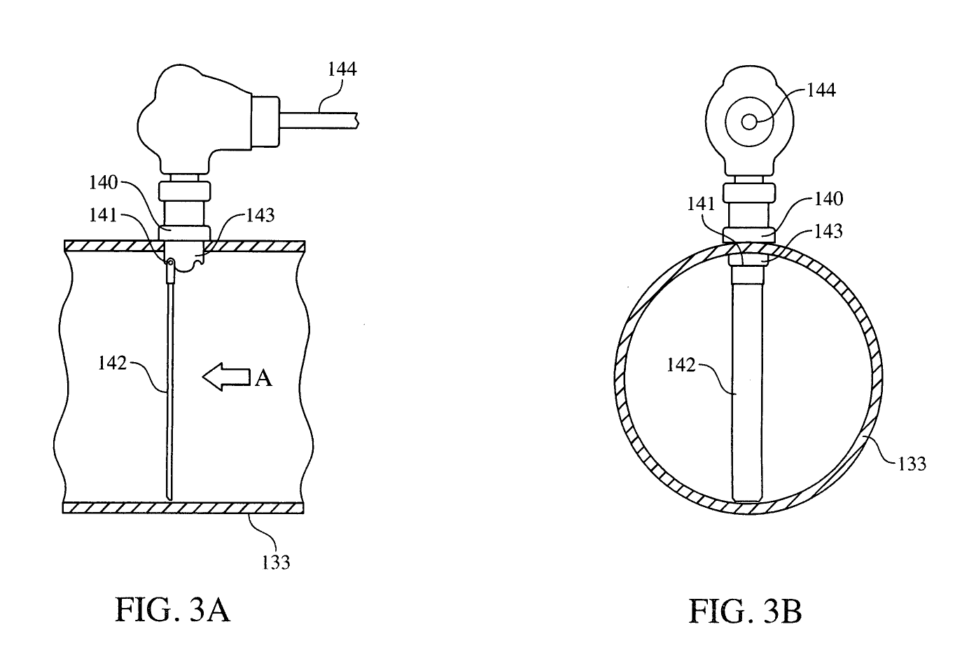

FIG. 3A is a cross-section of an horizontal conduit taken along the conduit length showing an embodiment sensor. Visible in FIG. 3A is the conduit 133, the sensor paddle 142, which is connected by a pivot 141 to the flow sensor base 143. Flow in the conduit in the direction indicated by arrow A causes movement of the paddle 142 which is detected by the sensor 140. An electrical signal activated by the movement of the paddle 142 is transmitted from the sensor by a connector 144 to an alarm box (not shown in FIG. 3A). In embodiments, the electrical signal is activated when the flow rate exceeds 5 gallons per minute, and is inactivated when the flow drops below that rate.

FIG. 3B is a cross-section of an horizontal conduit taken along across a conduit diameter showing an embodiment sensor. Visible in FIG. 3B is the conduit 133, the sensor paddle 142, which is connected by a pivot 141 to the flow sensor base 143. Flow in the conduit causes movement of the paddle 142 which is detected by the sensor 140. An electrical signal activated by movement of the paddle 142 is transmitted from the sensor by a connector 144 to an alarm box (not shown in FIG. 3B).

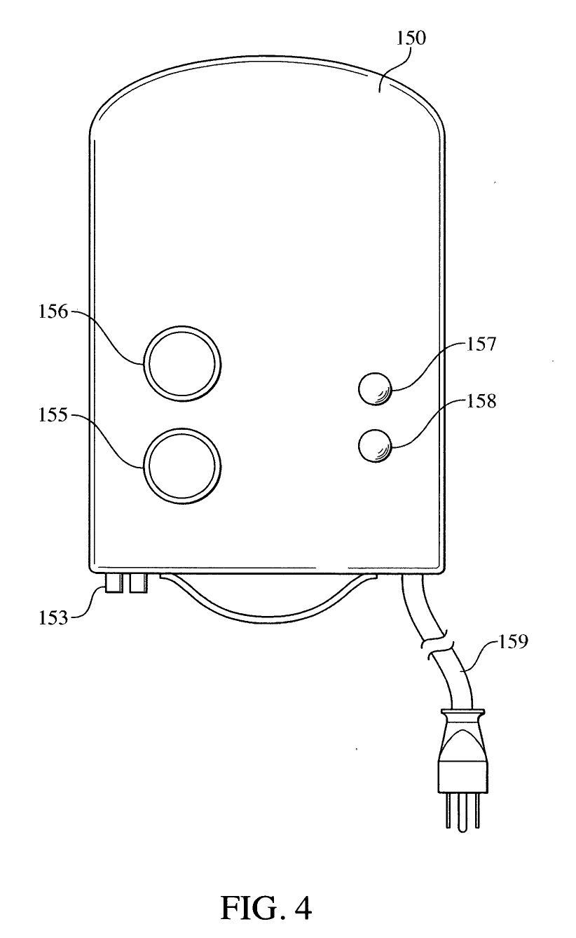

FIG. 4 is the front of an embodiment alarm box 150. Visible in FIG. 4 is a terminal 153 for connecting with the connector from the sensor. Also visible in FIG. 4 is a silence button 155 for muting the audible alarm, a test button 156 for assessing the operation of the alarm box, a flow light 157 which is illuminated when the sensor indicates flow in the secondary conduit, a power on light 158 which is illuminated when the control box has power, and a power plug 159. The operating characteristics are similar to operating a smoke alarm. In embodiments the alarm box is powered by a 9 volt batters. A low battery condition is indicated by a chirping sound. The flow sensor alarm box can be remotely located and, in some embodiments, is provided with internal auxiliary contacts for wiring into the building's central moniroring system or some other ancillary device.

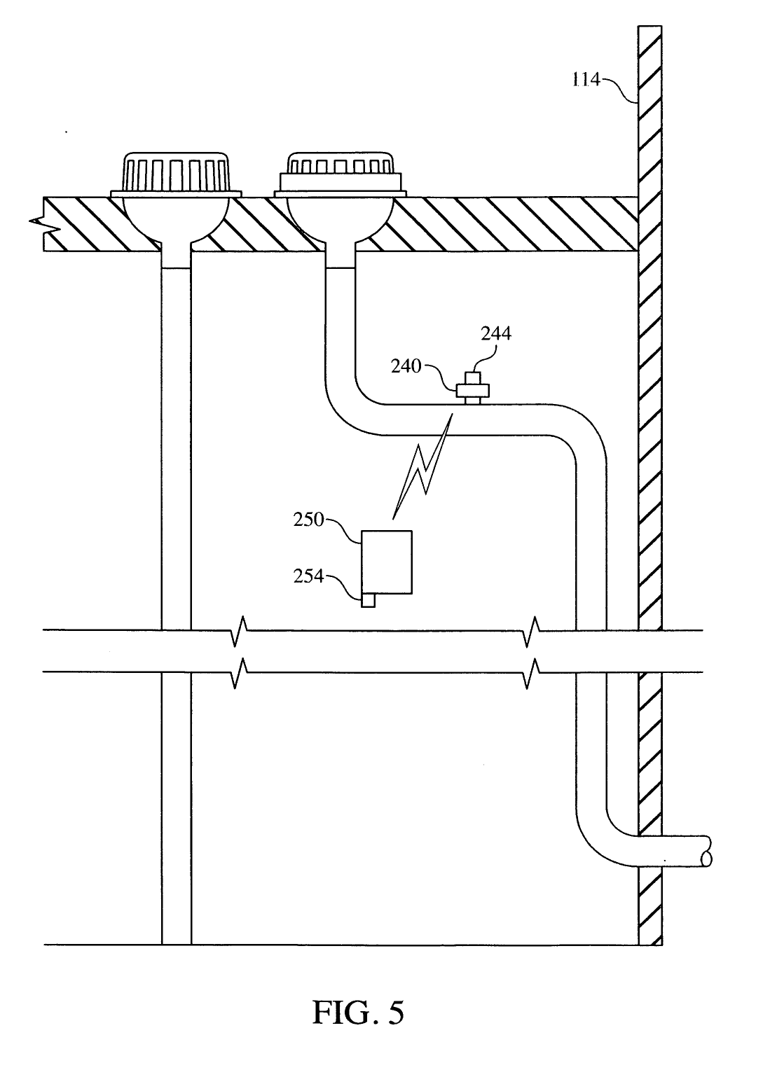

FIG. 5 is a cross-section of a flat roof building showing a primary drain and overflow drain with a second embodiment flow detection system. The elements of FIG. 5 is identical to those of FIG. 1 with the exception of the second embodiment flow detection system. In the second embodiment system the flow sensor 240 is not connected by a connector to the alarm box. Rather the second embodiment sensor 240 has a radio frequency transmitter 244 which emits a radio signal which is activated by the flow in the flow sensor. In the second embodiment system the alarm box 250 has a radio frequency receiver 254.

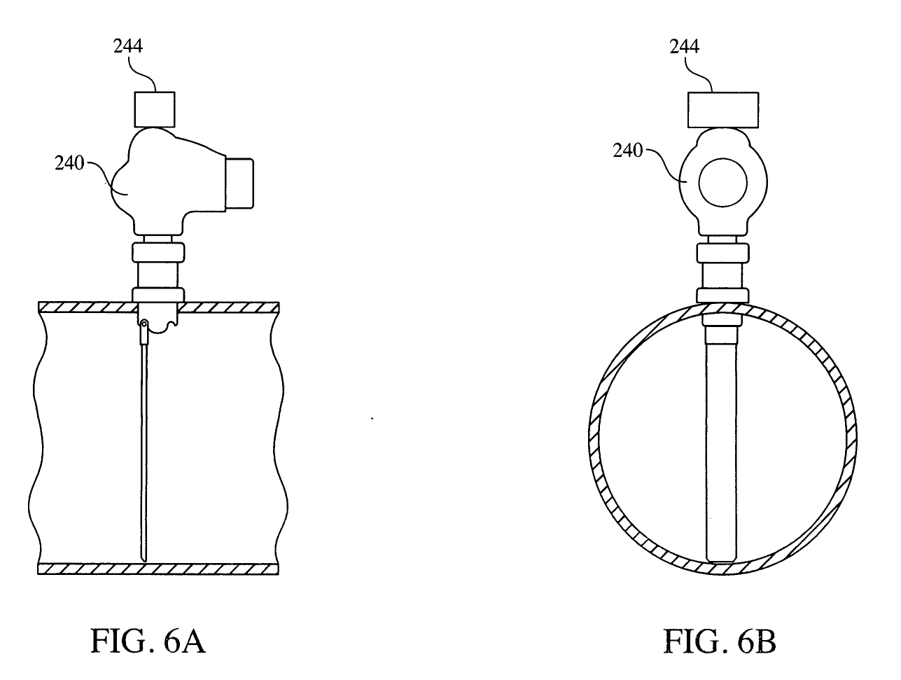

FIG. 6A is a cross-section of an horizontal conduit taken along the conduit length showing a second embodiment sensor. The features in FIG. 6A are identical to those in FIG. 3 A with the exception of the second embodiment flow detection system. In the second embodiment system the flow sensor 240 is not connected by a connector to the alarm box. Rather the second embodiment sensor 240 has a radio frequency transmitter 244 which emits a radio signal which is activated by flow in the flow sensor.

FIG. 6B is a cross-section of an horizontal conduit along a diameter of the conduit showing a second embodiment sensor. The features in FIG. 6B are identical to those in FIG. 3 B with the exception of the second embodiment flow detection system. In the second embodiment system the flow sensor 240 is not connected by a connector to the alarm box. Rather the second embodiment sensor 240 has a radio frequency transmitter 244 which emits a radio signal which is activated by the flow in the flow sensor.

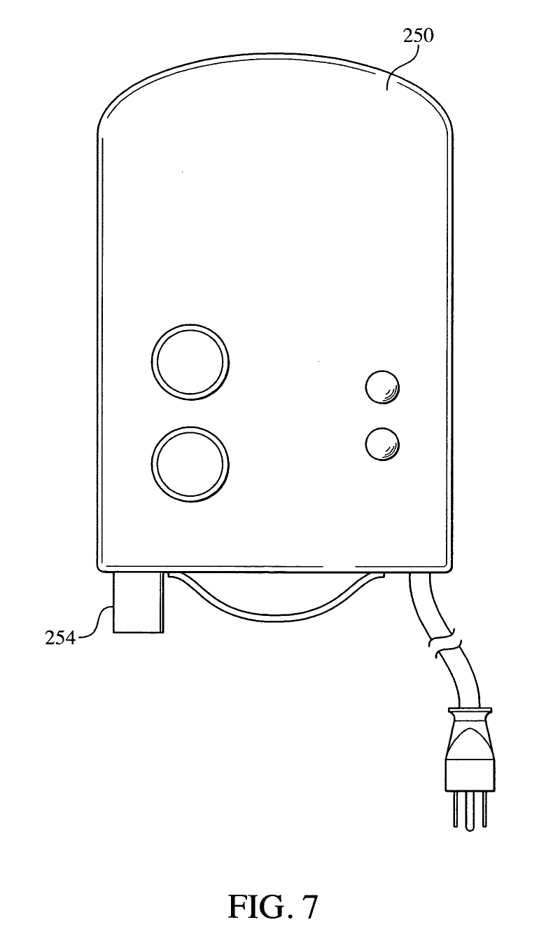

FIG. 7 is the front of a second embodiment alarm box. The elements of FIG. 7 are identical to FIG. 4 with the exception of the second embodiment system. The second embodiment alarm box 250 has a radio frequency receiver 254 rather than a terminal.

Embodiment conductors are made of any suitable strong, flexible, conductor wires or cables. The conductor may include provisions for providing electrical power from the alarm box to the sensor. Specifically contemplated are optical waveguide conductors. They would include an optical transmitter mounted on the sensor, an optical fiber, and a optical receiver mounted on the alarm box.

Embodiment wireless transmitter and receivers are any suitable system. One example is model RLB-55 obtainable from Black Box Corporation, Lawrence Pa.

Any suitable strong, impervious, corrosion resistant conduit can be used in embodiments. Embodiments include pipes of diameters from 3 inches to 12 inches. Embodiments include those conduits manufactured of iron, steel, copper, and polyvinyl chloride.

While a number of exemplary aspects and embodiments have been discussed above, those of skill in the art will recognize certain modifications, permutations, additions and subcombinations thereof. It is therefore intended that the following appended claims and claims hereafter introduced are interpreted to include all such modifications, permutations, additions and sub-combinations as are within their true spirit and scope. The applicant or applicants have attempted to disclose all the embodiments of the invention that could be reasonably foreseen. There may be unforeseeable insubstantial modifications that remain as equivalents.

I claim:

1. An alarm system for detecting the flow of water in a secondary emergency overflow roof drainage system having at least a portion of its conduit in a horizontal orientation, comprising:
a flow sensor in the horizontal conduit of the roof drainage system comprising:
a flow sensor with a sensor base,
the flow sensor attached to the horizontal conduit wall with the sensor base extending into the conduit lumen,
to a flow sensor vane,
the vane pivotally connected to the sensor base,
the vane extending from the sensor base into the lumen of the conduit,
the vane oriented in the conduit so the flow of water in the conduit causes the vane to swing about the pivot connection,
a flow sensor for converting the vane position into an electrical value,
an alarm box which provides a visual or audible signal in response to a predetermined electrical value, and
conductor means for conveying an electrical value from the flow switch to the alarm box.

2. The alarm system of claim 1 wherein the conductor means is a cable.

3. The alarm system of claim 1 wherein the conductor means is a wire, cable, or optical waveguide system.

4. An alarm system for detecting the flow of water in a secondary emergency overflow roof drainage system having at least a portion of its conduit in a horizontal orientation, comprising:
a flow sensor in the horizontal conduit of the roof drainage system comprising:
a flow sensor with a sensor base,
the flow sensor attached to the horizontal conduit wall with the sensor base extending into the conduit lumen,
a flow sensor vane,
the vane pivotally connected to the sensor base,
the vane extending from the sensor base into the lumen of the conduit,
the vane oriented in the conduit so the flow of water in the conduit causes the vane to swing about the pivot connection,
a flow sensor for converting the vane position into an electrical value,
an alarm box which provides a visual or audible signal in response to a predetermined electrical value, and
wireless means for conveying an electrical value from the flow switch to the alarm box.

5. The alarm system of claim 4 wherein the wireless means are a radio frequency transmitter and receiver.
